(19) United States
(12) Patent Application Publication
(10) Pub. No.: US 2012/0073391 A1
(43) Pub. Date: Mar. 29, 2012

(54) RAIN TEST DEVICE FOR WHOLE RAILWAY VEHICLE

(75) Inventor: XIAOYANG XU, Jilin (CN)

(73) Assignee: CHANGCHUN RAILWAY VEHICLE CO., LTD., JILIN (CN)

(21) Appl. No.: 13/310,366

(22) Filed: Dec. 2, 2011

Related U.S. Application Data
(63) Continuation of application No. PCT/CN2010/074804, filed on Jun. 30, 2010.

(30) Foreign Application Priority Data
Oct. 21, 2009 (CN) 200920094560.2

(51) Int. Cl. G01M 17/08

(52) U.S. Cl. 73/865.6

(57) ABSTRACT

A rain test device for a whole railway vehicle comprising a tunnel-shaped water spray pipeline, an underground reservoir, a main water pump, a water collecting flume and an underground sedimentation tank, wherein one end of the main water pump is connected with a suction foot valve to be extended into the underground reservoir, and the other end of the main water pump is connected to the tunnel-shaped water spray pipeline; the water collecting flume corresponds to the width of a vehicle body of the whole railway vehicle in the tunnel-shaped water spray pipeline and is in fluid communication with the underground sedimentation tank, and the underground sedimentation tank is further in fluid communication with the underground reservoir.

### CROSS-REFERENCE TO RELATED APPLICATIONS

This application is a continuation of International Application No. PCT/CN2010/074804, filed on Jun. 30, 2010, which claims the priority benefit of China Patent Application No. 200920094560.2, filed on Oct. 21, 2009. The contents of the above identified applications are incorporated herein by reference in their entirety.

### FIELD OF THE TECHNOLOGY

The present invention belongs to the technical field of railway vehicle manufacture, and more specifically relates to a rain test device for the rain proof performance of whole vehicle such as a railway vehicle, a multiple unit train and an urban rail vehicle.

### BACKGROUND

Currently, the test method for the rain proof performance of whole railway vehicle is performed by watering the vehicle to be tested using a water pipe or by sprinkling water on the vehicle using a single-row sprinkle water pipe. This method is undesirable and can not obtain good test effect. Moreover, the water is sprayed on the ground and can not be recycled, resulting in wasted energy and environmental pollution.

### SUMMARY

It is an object of the present invention to provide a rain test device for a whole railway vehicle, which can quickly test the rain proof performance with a good test effect, and solve the problems of energy-wasting and environmental pollution so as to realize circulation use of water.

In order to realize the above object, the present invention provides a rain test device for a whole railway vehicle, which comprises a tunnel-shaped water spray pipeline, an underground reservoir, a main water pump, a water collecting flume and an underground sedimentation tank, wherein one end of the main water pump is connected with a suction foot valve to be extended into the underground reservoir, and the other end of the main water pump is connected to the tunnel-shaped water spray pipeline. The water collecting flume corresponds to the width of a vehicle body of the whole railway vehicle in the tunnel-shaped water spray pipeline and is in fluid communication with the underground sedimentation tank, and the underground sedimentation tank is further in fluid communication with the underground reservoir.

A blow-down submersible pump is disposed at the bottom of the underground reservoir, and a blow-down draining well is connected with an outlet pipe of the blow-down submersible pump.

The present invention can completely cover the whole vehicle to carry out the rain test as one end of the main water pump is connected with the suction foot valve to be extended into the underground reservoir, and the other end of the main water pump is connected to the tunnel-shaped water spray pipeline. Moreover, since the water collecting flume corresponds the width of the vehicle body in the spray tunnel defined by the tunnel-shaped water spray pipeline and is in fluid communication with the underground sedimentation tank, and the underground sedimentation tank is further in fluid communication with the underground reservoir, the present invention can circularly supply water so as to solve the problems of energy-wasting and environmental pollution.

### BRIEF DESCRIPTION OF THE DRAWINGS

FIG. 1 is a structural schematic diagram of a rain test device according to present invention; and

FIG. 2 is a cross-section diagram during operation of the rain test device.

### DETAILED DESCRIPTION

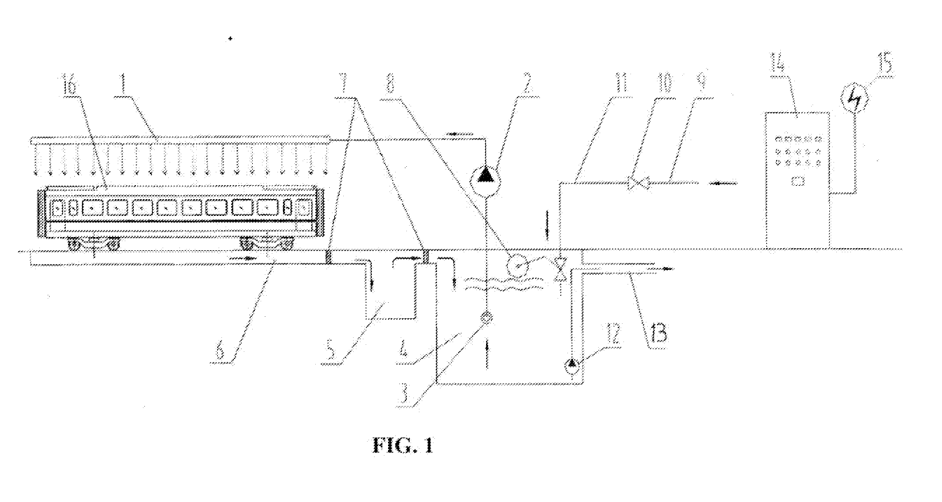

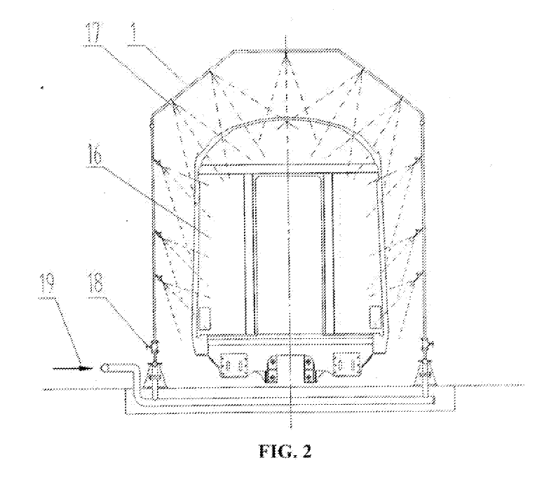

Referring to FIG. 1 and FIG. 2, the tunnel-shaped water spray pipeline 1 is used for completely covering the whole railway vehicle 16 to carry out the rain test. A suction pipe of a main water pump 2 is connected with a suction foot valve 3 to be extended into the water in an underground reservoir 4. The main water pump 2 starts up by operating the buttons for a variable frequency speed-regulating device and console 14 so that the water in the reservoir is pumped to form a pressure flow 19. The pressure flow 19 pumped by the main water pump 2 then enters into spray nozzles 17 of the tunnel-shaped water spray pipeline 1 to be sprayed to the surface of the railway vehicle 16. The water sprayed to the surface of the railway vehicle 16 falls on the ground, passes through a filter screen 7 and then flows into the underground sedimentation tank 5 via the water collecting flume 6. The impurities in the water settle down to the bottom of the underground sedimentation tank 5. The clean water at the upper portion of the underground sedimentation tank 5 flows into the underground reservoir 4 passing through another filter screen 7. After that, the water flowing into the underground reservoir 4 is pumped by the main water pump 2 to form the pressure flow 19 again, which enters into the tunnel-shaped water spray pipeline 1 to be sprayed to the surface of the railway vehicle 16 by the spray nozzles 17, and falls on the ground for the next circulation. A blow-down submersible pump 12 is disposed at the bottom of the underground reservoir 4, and an outlet pipe of the blow-down submersible pump 12 directly communicates with a blow-down draining well 13. When the quality of water in the underground reservoir 4 is dirty enough to need a water replacement, the corresponding button of the variable frequency speed-regulating device and console 14 is pressed to make the blow-down submersible pump 12 start up so that the sewage in the underground reservoir 4 flows into the blow-down draining well 13. When the sewage in the underground reservoir 4 is completely pumped out, new water can be supplemented to the reservoir by a water supply pipe 9. The water supply pipe 9 is connected to a fill/drain pipe 11 by a fill/drain valve 10. The fill/drain pipe 11 is inserted into the underground reservoir 4, and the head of the fill/drain pipe 11 is connected with a bottle gourd switch 8 so as to control the height of water level and close the water source automatically. A power source 15 supplies the power for the whole system, and it is connected to the variable frequency speed-regulating device and the control table 14 to control the main water pump 2 and the blow-down submersible pump 12. The variable frequency speed-regulating device and console 14 is provided with the buttons for controlling the startup of the main water pump 2 and the blow-down submersible pump 12. The frequency of a motor (not shown) can be changed by adjusting the numerical value of a display meter on the console so as to control the motor revolution of the main water pump 2, thereby the water flow and the water pressure can be adjusted.

What is claimed is:

1. A rain test device for a whole railway vehicle, comprising a tunnel-shaped water spray pipeline, an underground reservoir, a main water pump, a water collecting flume and an underground sedimentation tank, wherein one end of the main water pump is connected with a suction foot valve to be extended into the underground reservoir, and the other end of the main water pump is connected to the tunnel-shaped water spray pipeline; the water collecting flume corresponds to the width of a vehicle body of the whole railway vehicle in the tunnel-shaped water spray pipeline and is in fluid communication with the underground sedimentation tank, and the underground sedimentation tank is further in fluid communication with the underground reservoir.

2. The rain test device according to claim 1, further comprising a blow-down submersible pump disposed at the bottom of the underground reservoir, and a blow-down draining well is connected with an outlet pipe of the blow-down submersible pump.
